(19) United States
(12) Patent Application Publication
(10) Pub. No.: US 2005/0132285 A1
(43) Pub. Date: Jun. 16, 2005

(54) System and method for generating webpages

(76) Inventors: Sung-Chieh Chen, Taipei City (TW); Yen-Liang Lu, WhaLieng (TW); Pai-Pin Wang, Kuanhsi Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/876,082

(22) Filed: Jun. 24, 2004

(30) Foreign Application Priority Data
Dec. 12, 2003 (TW) 92135186

(51) Int. Cl. G06F 17/00

(52) U.S. Cl. 715/517

(57) ABSTRACT

A system for generating webpages. The system comprises a web data generating module, a format template editing module, a content template editing module, and an integration module. The web data generating module generates a format template and a content template according to a preset model, wherein the model comprises at least one page element. The format template editing module adjusts the format template, wherein the format template comprises at least one format element. The content template editing module adjusts the content template, wherein the content template comprises at least one content element. The integration module, connected to the format template adjusting module and the content template adjusting module, retrieves content element from the adjusted content template, combines it into corresponding format element of the adjusted format template, and generates the webpage accordingly.

### BACKGROUND OF THE INVENTION

1. Field of the Invention

The present invention relates to website development, and in particular to a system and method for generating webpages thereof.

2. Description of the Related Art

A conventional system for developing webpages is labor intensive and requires experts from different fields. Content for a webpage are first provided. The layout design thereof is then determined, and source code thereof is written. The development of content, layout design, and source code requires different specialties and is generally accomplished by different personnel. If the three described steps of webpage development are accomplished separately by different personnel, difficulties may arise resulting in prolonged lead time and reduced quality.

Furthermore, webpages must be developed individually even if they have a similar layout. Hence, work must be duplicated repeatedly to fit new content into a preset layout. Additionally, a particular webpage may be designed to be presented on certain platform with an appearance defined by a preset layout. If the platform or layout changes, the webpage must be redeveloped.

Hence, there is a need for a webpage development system which ameliorates the disadvantages of the existing technology.

### SUMMARY OF THE INVENTION

Accordingly, the present invention provides a system and method for generating webpages by combining a format template and a content template.

The present invention provides a system for generating webpages comprising a web data generating module, a format template editing module, a content template editing module, and an integration module.

The web data generating module generates a format template and a content template according to a preset model, wherein the model comprises at least one page element corresponding to the page element.

The format template editing module adjusts the format template, wherein the format template comprises at least one format element corresponding to the page element.

The content template editing module adjusts the content template, wherein the content template comprises at least one content element.

The integration module, connected to the format template adjusting module and the content template adjusting module, retrieves the content element from the adjusted content template, combines it into the corresponding format element of the adjusted format template, and generates the webpages as defined by the model accordingly.

The present invention also provides a method for generating webpages. First, a model is provided, wherein the model comprises at least one page element. Then, a format template and a content template are generated according to the model. Next, the format template is adjusted, wherein the format template comprises at least one format element corresponding to the page element. Then, the content template is adjusted, wherein the content template comprises at least one content element corresponding to the page element. After the format template and content template are adjusted, the content element is retrieved from the adjusted content template, and combined into the corresponding format element of the adjusted format template to generate an webpages accordingly.

The above-mentioned method may take the form of program code embodied in a tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a system for generating webpages according to the present invention;

FIG. 2 is a flowchart of a method for generating a webpage of the system of FIG. 1;

FIG. 3 illustrates a layout of a webpage according to the embodiment of the present invention;

FIG. 4 illustrates a model for a webpage according to the embodiment of the present invention;

FIG. 5 illustrates a format template for the model of FIG. 4;

FIG. 6 illustrates a content template for the model of FIG. 4;

FIG. 7 illustrates an adjusted format template for a webpage according to the embodiment of the present invention;

FIG. 8 illustrates an adjusted content template for a webpage according to the embodiment of the present invention;

FIG. 9 shows a webpage according to the embodiment of the present invention; and

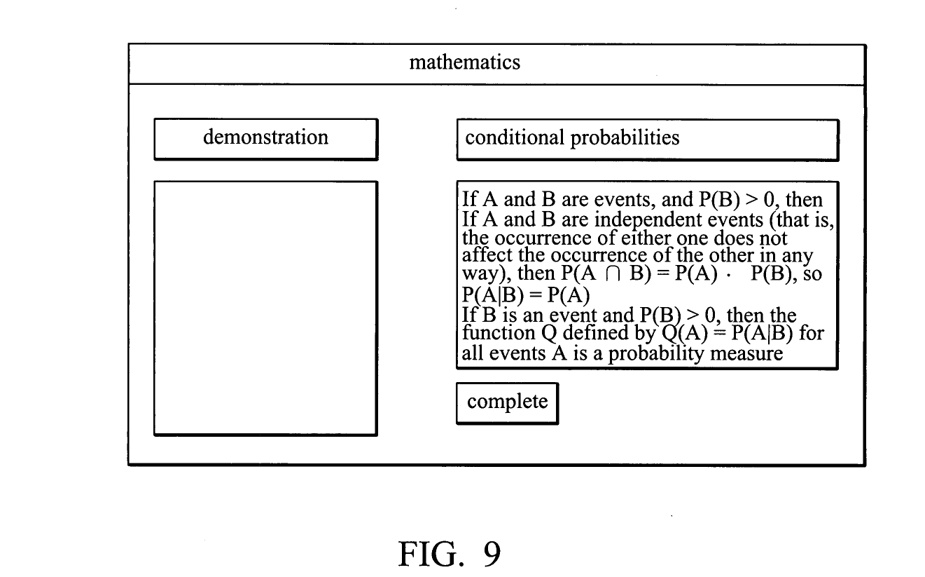

FIG. 10 is a diagram of a storage medium storing a computer program providing the webpage development method according to the present invention.

### DETAILED DESCRIPTION OF THE INVENTION

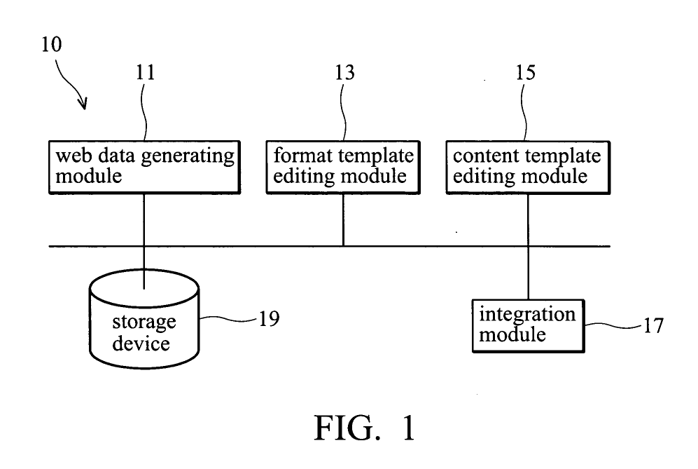

FIG. 1 is a schematic view of a system for generating webpages according to the present invention.

A system 10 for generating a webpage includes a web data generating module 11, a format template editing module 13, a content template editing module 15, an integration module 17, and a storage device 19.

The web data generating module 11 generates a format template and a content template according to a preset model, wherein the model comprises at least one page element. The preset model is stored in the storage device 19. The aforementioned format template comprises at least one format element corresponding to the page element. The aforementioned content template comprises at least one content element corresponding to the page element.

The format template editing module 13 adjusts the format template to meet requirements. Similarly, the adjusted format template comprises at least one format element corresponding to the page element.

The content template editing module 15 adjusts the content template. Similarly, the adjusted content template comprises at least one content element.

The integration module 17 retrieves the content element from the adjusted content template, combines it with a corresponding format element of the adjusted format template, and generates the webpage as defined by the model.

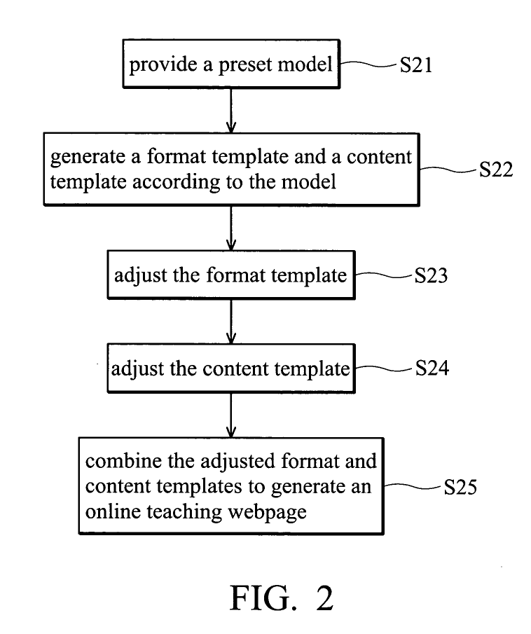

Using FIG. 2 as an example, which is a flowchart of a method for generating webpages of the system of FIG. 1.

First, a preset model defining a webpage is provided (step S21). The model comprises at least one page element. The content template comprises at least one content element corresponding to the page element.

Second, a format template and a content template are generated according to the model (step S22). The format template comprises at least one format element corresponding to the page element.

Then, the format template is adjusted to meet requirements (step S23). Similarly, the adjusted format template comprises at least one format element corresponding to the page element. The content template is also adjusted to meet requirements (step S24). Similarly, the content template comprises at least one content element corresponding to the page element.

Next, the content element is retrieved from the adjusted content template and combined into a corresponding format element of the adjusted format template, and thus the webpage as defined by the model is generated (step S25).

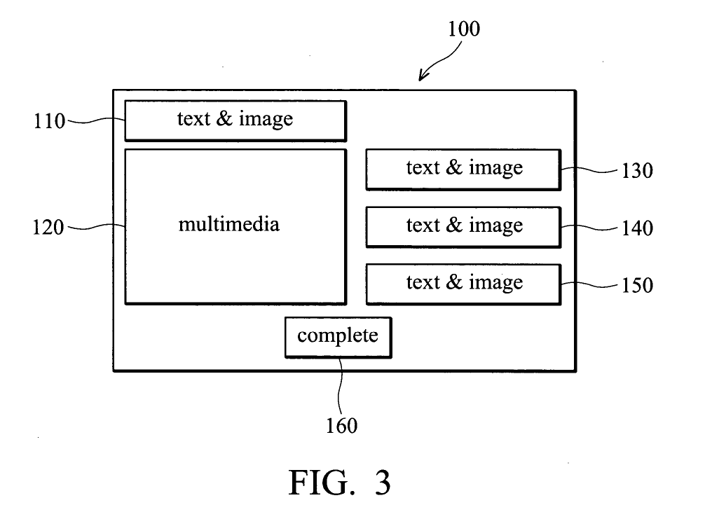

Referring to FIGS. 3˜10, details of the aforementioned webpage development are described in the following. FIG. 3 illustrates a layout of a webpage. According to the preset layout design, the webpage 100 contains page elements 110, 120, 130, 140, 150, and 160. The page elements can be any kind of object, such as a text object, an image object, a multimedia object, or a combination thereof. According to the embodiment, page elements 110, 130, 140, and 150 are text objects, and page element 120 is a multimedia object. Page element 160 represents an icon for ending display of webpage.

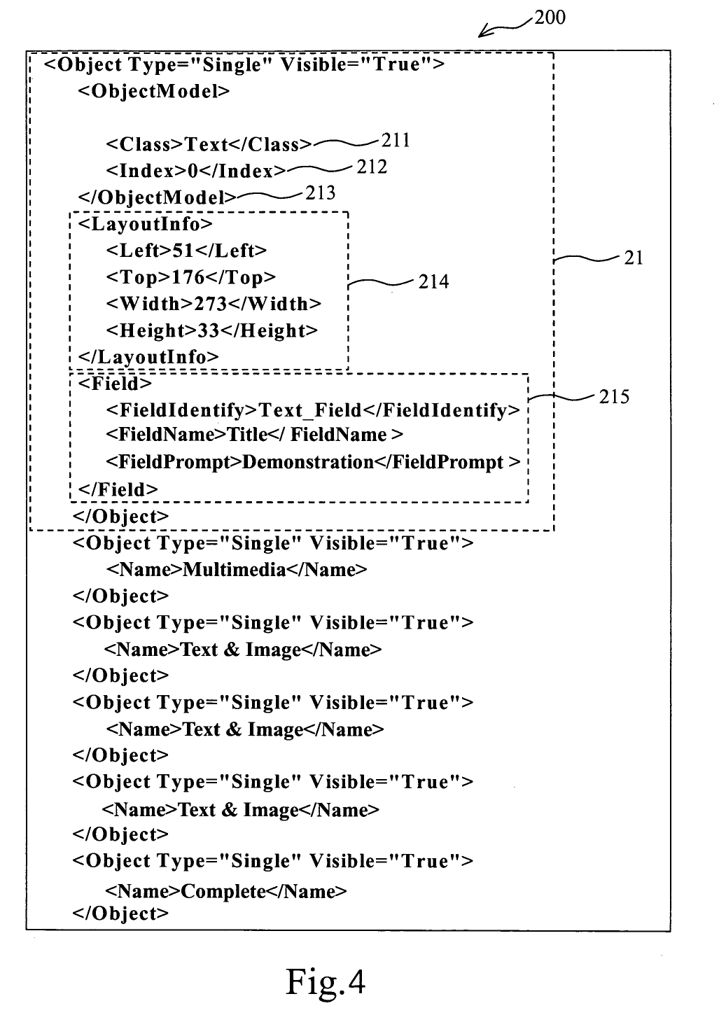

FIG. 4 illustrates a model for the layout design of FIG. 3. Model 20 is an extensible Markup Language (XML) document. In the XML document, each page element is represented using a markup tag with user-defined name ‘object’ and corresponding attributes. A pair of object markup tags enclose object information for the page element and corresponding layout information. For example, part 21 in the model 20 corresponds to page element 110, comprising object name 211, object class 212, object index 213, and corresponding layout information 214. The layout information 214 specifies position and appearance for the object. According to the model 20, the object class and object index for page element 110 are ‘text’ and ‘0’, respectively. The object class and object index are considered as page element identification. For example, the integration module uses the page element identification ‘text 0’ to identify the format element and content element corresponding to page element 110. The text object for page element 110 comprises a text field specified in part 215 of model 20.

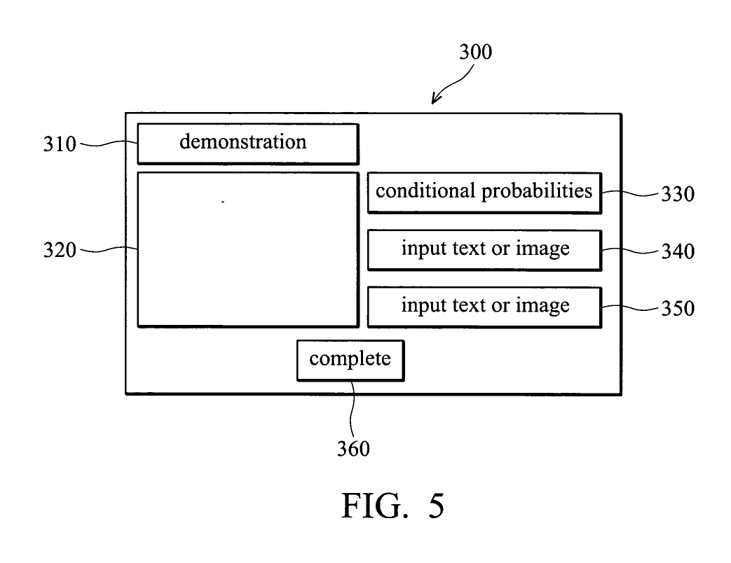

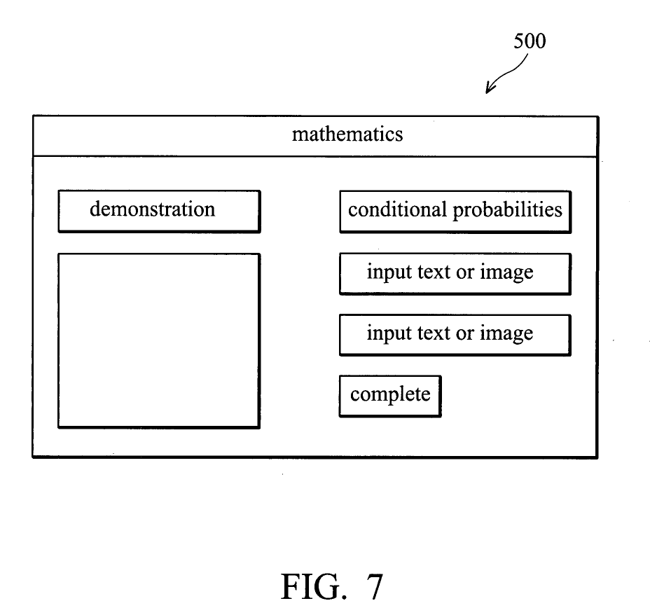

FIG. 5 illustrates a format template for the model of FIG. 4. A format template 300 uses Hyper Text Markup Language (HTML) to specify format as defined by the model. The format template 300 comprises format elements 310, 320, 330, 340, 350 and 360 corresponding to the page elements 110, 120, 130, 140, 150 and 160, respectively. The format template can be further adjusted using the format template editing module to meet requirements. The adjusted format template is shown in FIG. 7. The adjusted format template 500 has a structure similar to the format template 300. The adjusted format template comprises 6 adjusted format elements corresponding to the format elements 310˜350, while the arrangement and appearance of the adjusted format elements slightly differ from the original format.

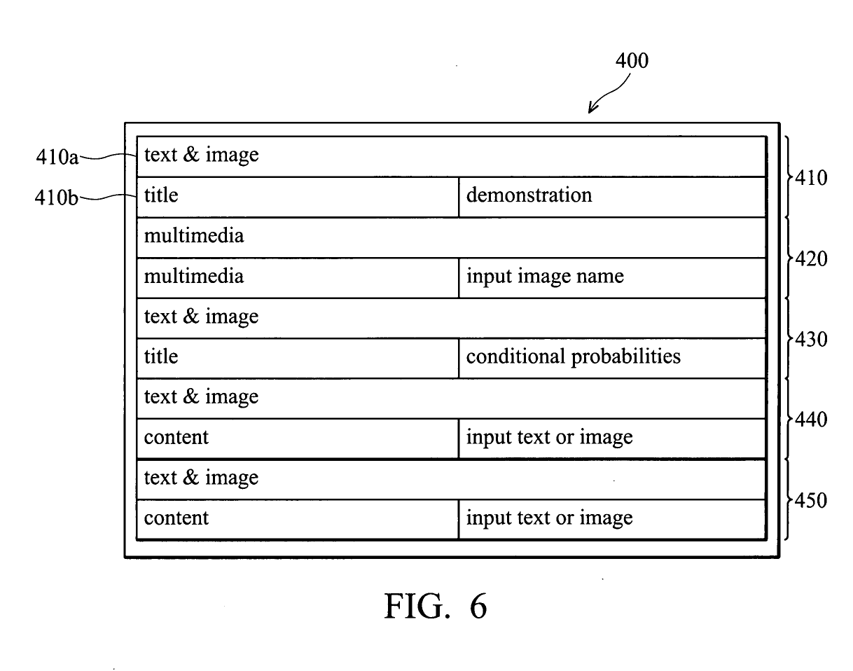

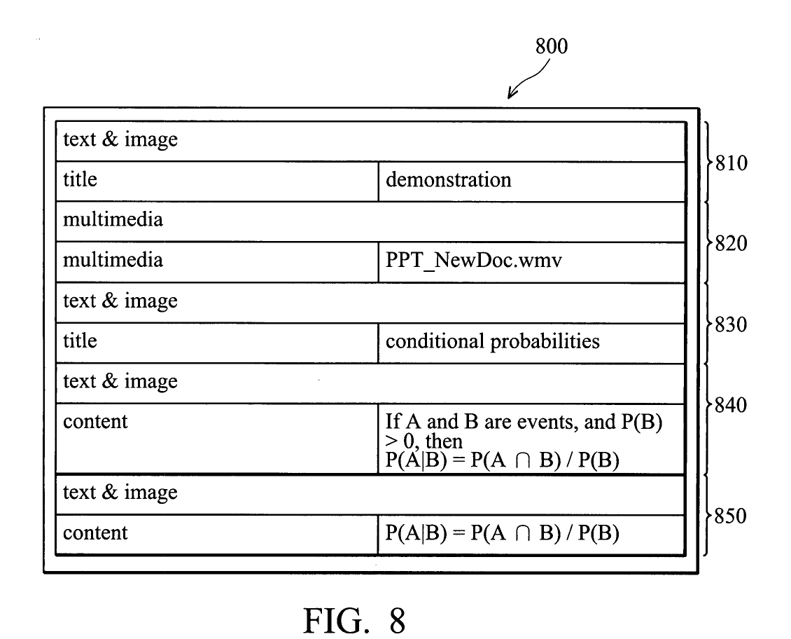

FIG. 6 illustrates a content template for the model of FIG. 4. The content template 400 is a program readable data file, such as a Microsoft Word document. The content template 400 comprises content elements 410, 420, 430, 440, and 450, corresponding to the page elements 110, 120, 130, 140, and 150. Each content element has 2 fields, one for an object name and the other for content presented in the corresponding page element. For example, content element 410 comprises fields 410a and 410b. Field 410a specifies object name for page element 110, and field 410b specifies content presented in page element 110. The content template can be further adjusted to meet requirements. The adjusted content template is shown in FIG. 8. The adjusted content template 800 has a structure similar to the original content template 400. The adjusted content template comprises 6 adjusted content elements corresponding to the original content elements 410˜450, while the presented content thereof is different form the original content. For example, field 420a of content element 420 contains a file name for video information, PPT_NewDoc.wmv.

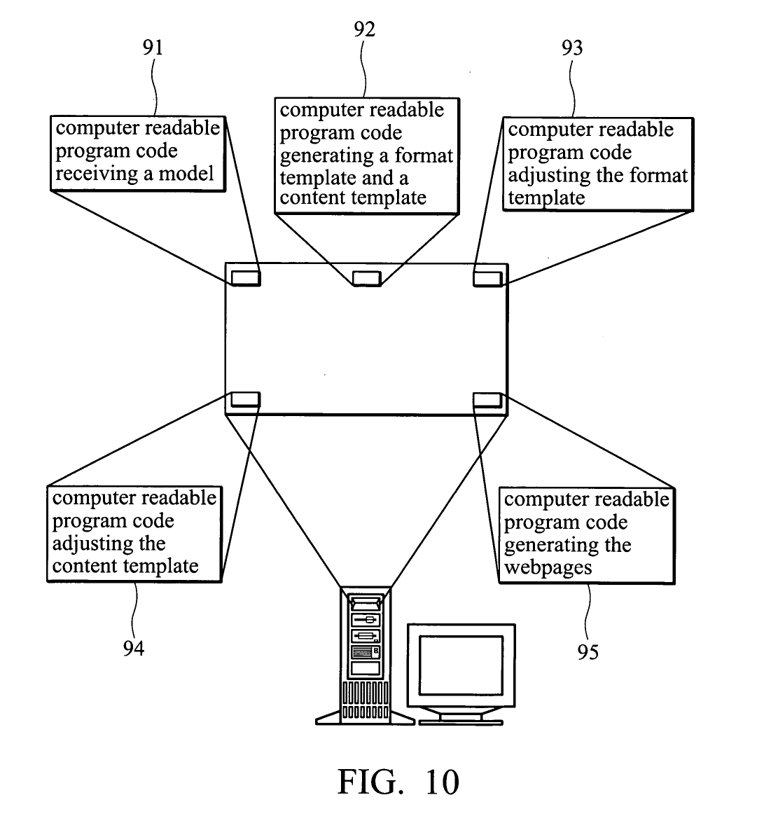

FIG. 10 shows a webpage according to the embodiment of the present invention.

The method of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

FIG. 10 is a diagram of a storage medium storing a computer program providing the webpage development method according to the present invention. The computer program product comprises a computer usable storage medium having computer readable program code embodied in the medium, the computer readable program code comprising computer readable program code 91 receiving a model, computer readable program code 92 generating a format template and a content template according to the model, computer readable program code 93 adjusting the format template, computer readable program code 94 adjusting the content template, computer readable program code 95 generating the webpages.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A system for generating a webpage, comprising:
a web data generating module generating a format template and a content template according to a preset model, wherein the model comprises at least one page element;
a format template editing module adjusting the format template, wherein the format template comprises at least one format element;
a content template editing module adjusting the content template, wherein the content template comprises at least one content element; and
an integration module, connected to the format template adjusting module and the content template adjusting module, retrieving the content element from the adjusted content template, combining it into the corresponding format element of the adjusted format template, and generating a webpage as defined by the model accordingly.

2. The system of claim 1, wherein the page element comprises object information and layout information thereof.

3. The system of claim 2, wherein the object information comprises object name, object class, and object index.

4. The system of claim 2, wherein the layout information specifies position and appearance for the object.

5. The system of claim 1, wherein the model is an extensible Markup Language (XML) document.

6. The system of claim 1, wherein the format template is a Hyper Text Markup Language (HTML) template.

7. The system of claim 1, wherein the content template is a program readable data file.

8. A method for generating a webpage, comprising:
providing a model, wherein the model comprises at least one page element;
generating a format template and a content template according to the model;
adjusting the format template, wherein the format template comprises at least one format element;
adjusting the content template, wherein the content template comprises at least one content element;
retrieving the content element from the adjusted content template;
combining the content element into the corresponding format element of the adjusted format template; and
generating a webpage as defined by the model accordingly.

9. The method of claim 8, wherein the model comprises object information for the webpage and layout information for the object.

10. The method of claim 9, wherein the object information comprises object name, object class, and object index.

11. The method of claim 9, wherein the layout information specifies position and appearance for the object.

12. The method of claim 8, wherein the model is an extensible Markup Language (XML) document.

13. The method of claim 8, wherein the format template is a Hyper Text Markup Language (HTML) template.

14. The method of claim 8, wherein the content template is a program readable data file.

15. A storage medium for storing a computer program providing a method for webpage development, the method comprising:
receiving a model, wherein the model comprises at least one page element;
generating a format template and a content template according to the model;
adjusting the format template, wherein the format template comprises at least one format element;
adjusting the content template, wherein the content template comprises at least one content element;
retrieving the content element from the adjusted content template;
combining the content element into the corresponding format element of the adjusted format template; and
generating a webpage as defined by the model accordingly.

16. The storage medium of claim 15, wherein the model comprises object information for the webpage and layout information for the object.

17. The storage medium of claim 16, wherein the object information comprises object name, object class, and object index.

18. The storage medium of claim 16, wherein the layout information specifies position and appearance for the object.

19. The storage medium of claim 15, wherein the model is an extensible Markup Language (XML) document.

20. The storage medium of claim 15, wherein the format template is a Hyper Text Markup Language (HTML) template.

21. The storage medium of claim 15, wherein the content template is a program readable data file.
